(19) United States
(12) Patent Application Publication
(10) Pub. No.: US 2014/0185213 A1
(43) Pub. Date: Jul. 3, 2014

(54) BEZEL OF ELECTRONIC DEVICE

(71) Applicants: HON HAI PRECISION INDUSTRY CO., LTD., New Taipei (TW); HONG FU JIN PRECISION INDUSTRY (WUHAN) CO., LTD., Wuhan (CN)

(72) Inventors: CHUNG CHAI, New Taipei (TW); ZHI-QIANG LI, Wuhan (CN); ZHI-LONG LI, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/058,952

(22) Filed: Oct. 21, 2013

(30) Foreign Application Priority Data
Dec. 28, 2012 (CN) 2012105825590

(51) Int. Cl. G06F 1/18

(52) U.S. Cl. CPC G06F 1/182
USPC 361/679.02

(57) ABSTRACT

A bezel of an electronic device includes an inner panel, a door, and a bar. The inner panel defines an opening. The two guiding slots are defined in the inner panel. The door is rotatably mounted to the inner panel. The door includes two pivot pins engaged with the two guiding slots. Each of the two guiding slots is substantially U-shaped. The bar is pivotally mounted to the inner panel and the door at two opposite ends. The bar is substantially U-shaped. The door is configured to rotate from a closed position to an open position. The door covers the opening in the closed position. The two pivot pins are located at ends of the two guiding slots and the door keeps a space away from the inner panel in the open position.

### BACKGROUND

1. Technical Field

The disclosure generally relates to bezels of electronic devices.

2. Description of Related Art

A bezel of an electronic device usually defines a plurality of input and output ports and an opening for receiving CD-ROM driver in a panel. The bezel may include a door to cover the plurality of input and output ports and the opening. The door is rotatable relative to the panel through a pivot axis. However, a side edge of the door is adjacent to the panel and may block the plurality of input and output ports and the opening. There is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric, and cutaway view of a bezel in one embodiment.

FIG. 2 is similar to FIG. 1, but shown from another aspect.

FIG. 3 is similar to FIG. 2, but shown from another aspect.

FIG. 4 is an assembled view of the bezel of FIG. 1.

FIG. 5 is an assembled view of the bezel of FIG. 2.

FIG. 6 is similar to FIG. 5, but a door is in an open position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

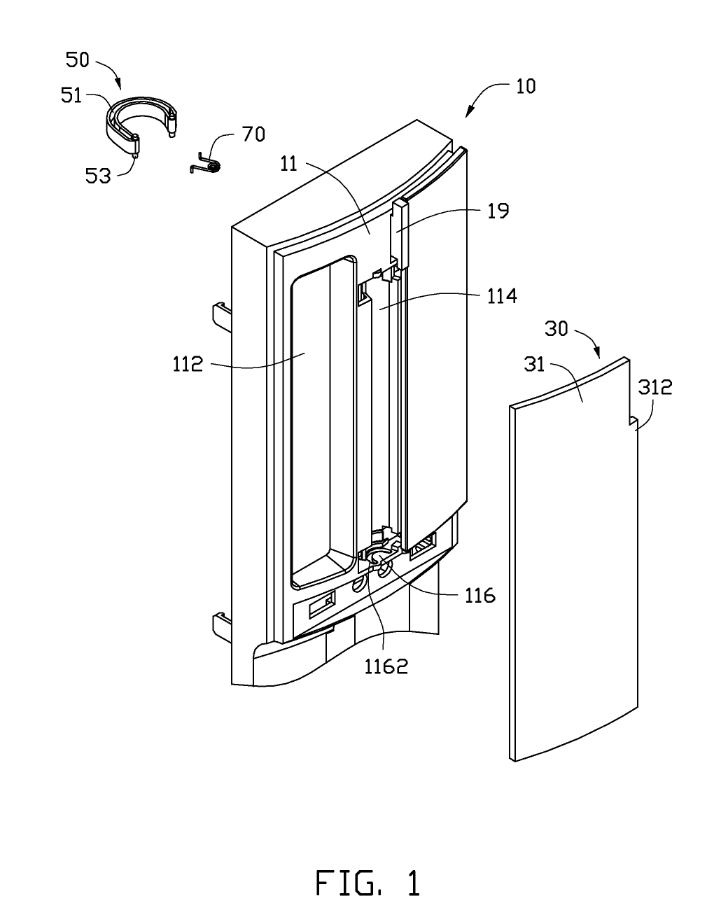

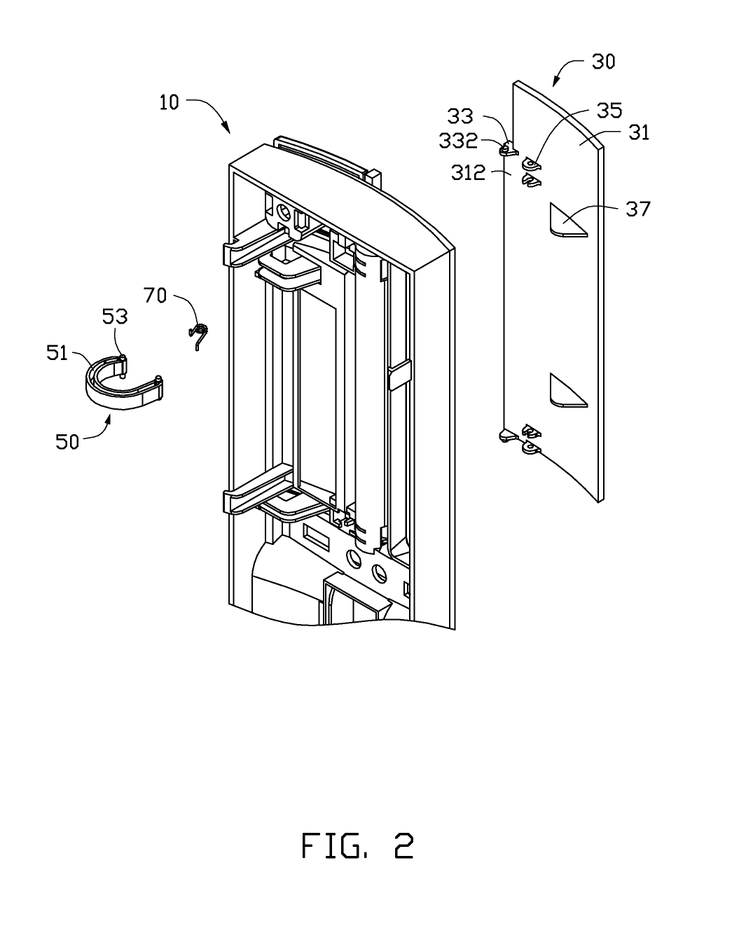

FIG. 1 and FIG. 2 are isometric views of a bezel of an electronic device. The electronic device may be a computer. The bezel includes an inner panel 11, a door 30, a bar 50, and a resilient element 70.

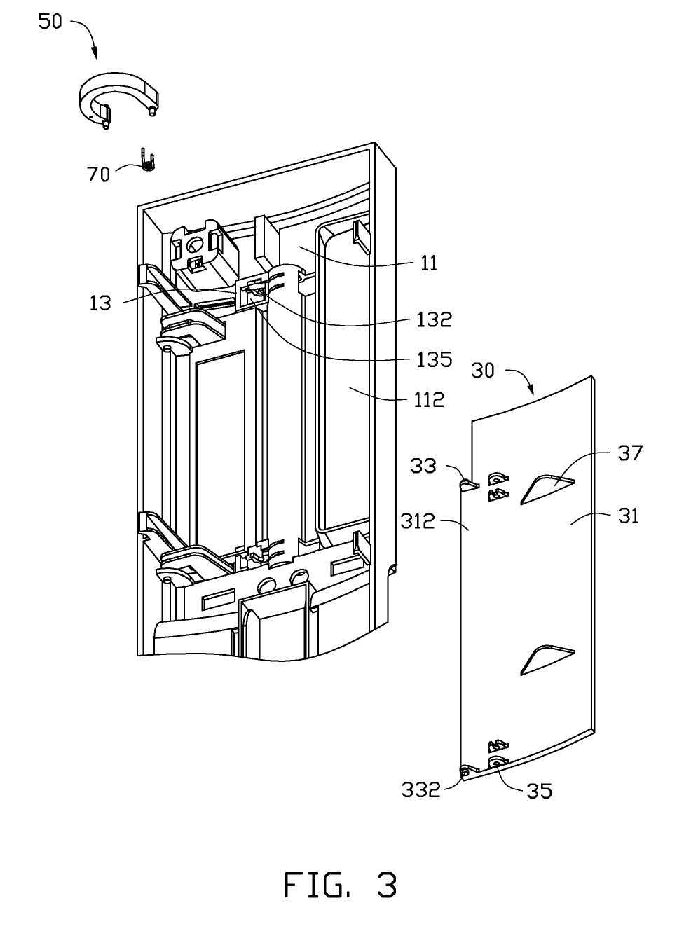

FIG. 3 illustrates another isometric view of the bezel of the electronic device. The inner panel 11 defines an opening 112 for receiving a CD-ROM driver. A pivot groove 114 is defined in the inner panel 11. The pivot groove 114 is located in a side of the opening 112. A cross-section of the pivot groove 114 is substantially arcuate. Two sidewalls 116 are located on opposite sides of the pivot groove 114. A guiding slot 1162 is defined in each of the two sidewalls 116. Each guiding slot 1162 is substantially U-shaped. A button 19 is located on the inner panel 11 for controlling the CD-ROM driver. A fixing portion 13 is located on an inner side of the inner panel 11. A through hole 135 and a pivot hole 132 is defined in the fixing portion 13.

The door 30 includes a door panel 31 and an engaging flange 312 located on a side of the door panel 31. A pair of pivot tabs 33 is located on the engaging flange 312 of the door panel 31. A pivot pin 332 protrudes from each pivot tab 33. A pair of pivot portions 35 and two ears 37 protrudes from an inner surface of the door panel 31. The door panel 31 is substantially rectangular. The two pivot pins 332 extend along a pivot axis, and the pivot axis is substantially parallel to the door panel 31.

The bar 50 is resilient and is substantially U-shaped. Two pivot posts 53 protrude from two opposite ends of the bar 50. An extending groove 51 is defined along an extending direction of the bar 50.

The resilient element 70 is a coil spring.

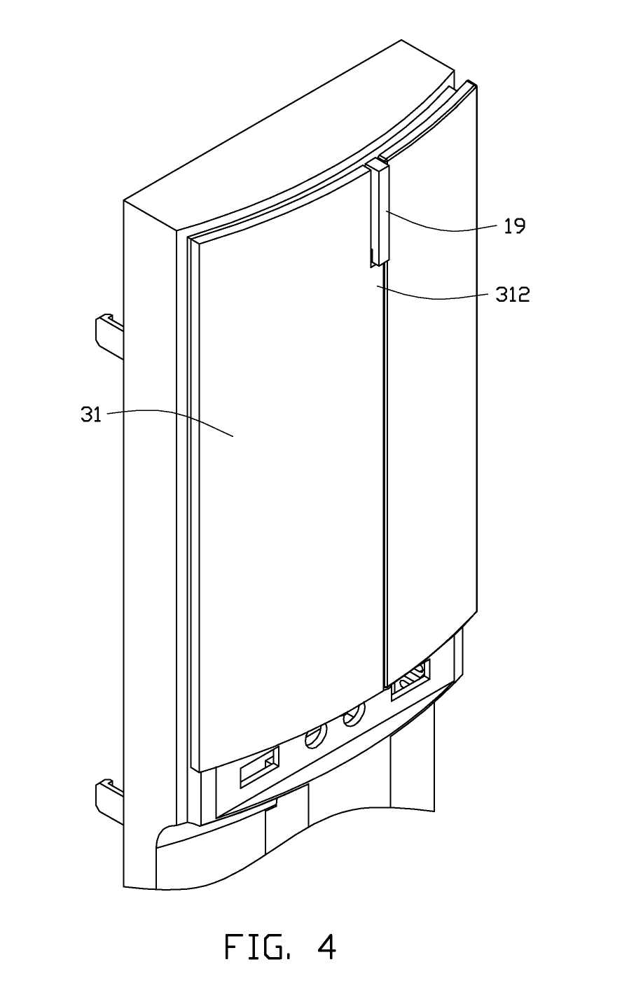

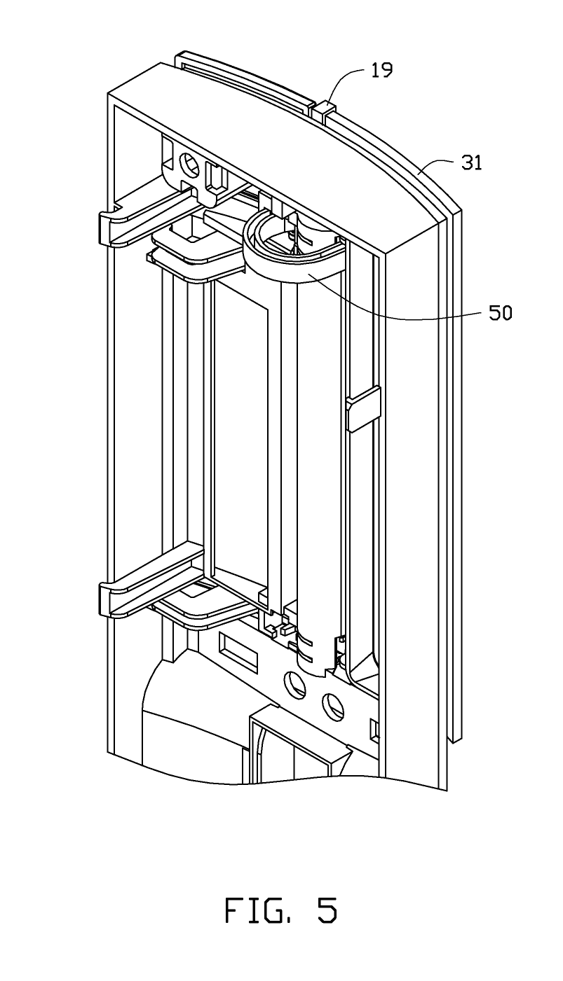

FIG. 4 and FIG. 5 illustrate two assembled views of an embodiment of the bezel. In assembly, the two pivot pins 332 are engaged with the two guiding slots 1162, so that the pivot pins 332 can slide along the guiding slots 1162. A first end of the bar 50 is engaged with the fixing portion 13 of the inner panel 11. A second end of the bar 50 extends through the inner panel 11 from the inner side of the inner panel 11 to an outer side of the inner panel 11. The other end of the bar 50 is pivoted to the pair of pivot portions 35. The resilient element 70 is located on the first end of the bar 50. The resilient element 70 pulls the door 30 to the inner panel 11. The door 30 is located in a closed position. The door 30 is substantially parallel to the inner panel 11 and covers the opening 112. The two ears 37 extend towards the opening 112. The button 19 is located on a side of the door 30. The engaging flange 312 partially covers the pivot groove 114.

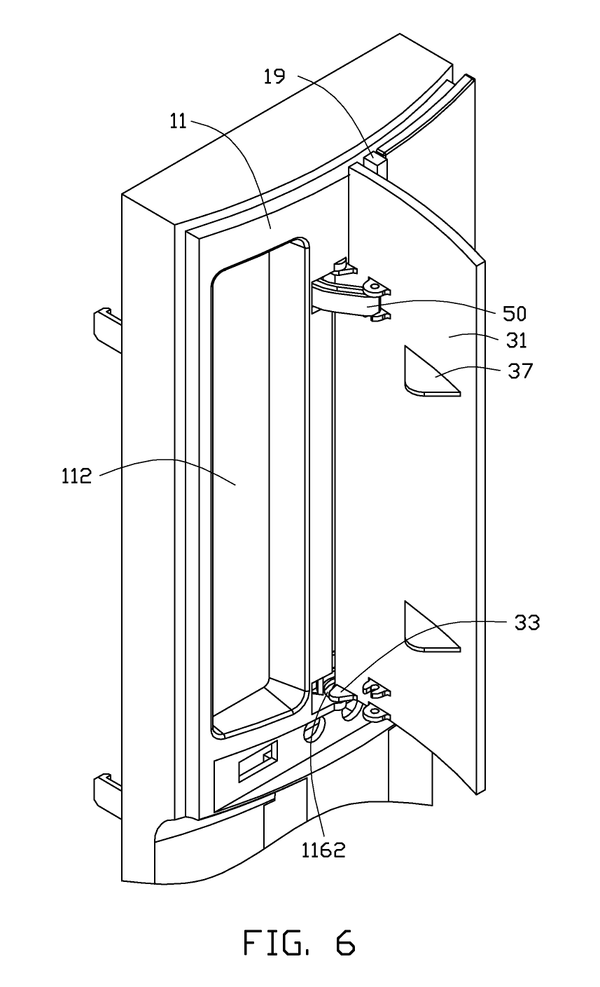

FIG. 6 illustrates another assembled view of the bezel, and the door 30 is opened relative to the inner panel 11. In use, the button 19 is manually pressed to control the CD-ROM driver (not shown) to move out of the inner panel 11. The door 30 is urged to rotate from the closed position to an open position. The two pivot pins 332 move to the ends of the two guiding slots 1162 and the door 30 moves away from the inner panel 11. The engaging flange 312 rotates to the pivot groove 114. In the open position, an angel of the door 30 relative to the inner panel 11 is equal or smaller than 90 degrees. When the CD-ROM driver retrieves into the opening 112, the door 30 is pulled by the bar 50 and is rotated to the closed position from the open position.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A bezel of an electronic device, comprising:
an inner panel defining an opening, and two guiding slots defined in the inner panel;
a door rotatably mounted to the inner panel, and the door comprising two pivot pins engaged with the two guiding slots; and
a bar pivotally mounted to the inner panel and the door, and the bar being substantially U-shaped,
wherein the door is rotatable from a closed position, where the door covers the opening, to an open position, where the two pivot pins are located at ends of the two guiding slots and the door is spaced from the inner panel.

2. The bezel of claim 1, further comprising a resilient element located on the bar, wherein the resilient element is configured to pull the door toward the inner panel.

3. The bezel of claim 1, wherein the bar is resilient.

4. The bezel of claim 1, wherein the door further comprises a door panel, and the two pivot pins are substantially parallel to the door panel.

5. The bezel of claim 4, wherein an ear protrudes from the door panel towards the opening.

6. The bezel of claim 4, wherein the door panel further comprises an engaging flange, the engaging flange is located on side of the door panel, a pivot groove is defined in the inner panel, and the engaging flange is located in the pivot groove when the door is in the open position.

7. The bezel of claim 6, wherein a button is located on the inner panel and on a side of the door, and the button is aligned with the engaging flange when the door is in the closed position.

8. The bezel of claim 1, wherein each of the two guiding slots is substantially U-shaped.

9. The bezel of claim 1, wherein when the door is in the open position, an angel of the door between the inner panel is equal or smaller than 90 degrees.

10. A bezel of an electronic device, comprising:
an inner panel defining an opening, and two guiding slots defined in the inner panel, each of the two guiding slots is substantially U-shaped;
a door rotatably mounted to the inner panel, and the door comprising two pivot pins engaged with the two guiding slots; and
a bar pivotally mounted to the inner panel and the door at two opposite ends,
wherein the door is configured to rotate from a closed position, where the door covers the opening; to an open position, where the two pivot pins are located at ends of the two guiding slots and the door keeps a space away from the inner panel.

11. The bezel of claim 10, further comprising a resilient element located on the bar, wherein the resilient element is configured to pull the door to the inner panel.

12. The bezel of claim 10, wherein the bar is resilient.

13. The bezel of claim 10, wherein the door further comprises a door panel, and the two pivot pins are substantially parallel to the door panel.

14. The bezel of claim 13, wherein an ear protrudes from the door panel towards the opening.

15. The bezel of claim 13, wherein the door panel further comprises an engaging flange, the engaging flange is located on side of the door panel, a groove is defined in the inner panel, and the engaging flange is located in the groove when the door is in the open position.

16. The bezel of claim 15, wherein a button is located on the inner panel and on a side of the door, and the button is aligned with the engaging flange when the door is in the closed position.

17. The bezel of claim 10, wherein the bar being substantially U-shaped.

18. The bezel of claim 10, wherein an angel of the door relative to the inner panel in the open position is equal or smaller than 90 degrees.
